(19) United States
(12) Patent Application Publication
(10) Pub. No.: US 2007/0154089 A1
(43) Pub. Date: Jul. 5, 2007

(54) Method and apparatus for calculating image histogram with configurable granularity

(76) Inventor: Chang-Jung Kao, Jhonghe City (TW)

Correspondence Address: RABIN & Berdo, PC, 1101 14TH STREET, NW, SUITE 500, WASHINGTON, DC, 20005, US

(21) Appl. No.: 11/322,345

(22) Filed: Jan. 3, 2006

(51) Int. Cl. G06K 9/00

(52) U.S. Cl. 382/168

(57) ABSTRACT

An apparatus and method for calculating histograms with configurable granularity. Histogram values of a histogram for an M-bit image with different requirements are calculated using a histogram calculation circuit including N cumulative calculation devices with boundary values configurable in one or more iterations, where N is smaller than 2M. In each iteration, boundary values of the N cumulative calculation devices are set and an image data signal is inputted to the histogram calculation circuit, so as to obtain a set of histogram values for the iteration. After the iterations are completed, the histogram values of the desired histogram are obtained. Thus, computation resource provided by the corresponding circuit can be sufficiently utilized and a reduced hardware cost can be achieved.

### BACKGROUND OF THE INVENTION

1. Field of the Invention

The invention relates in general to image processing, and more particularly to image histogram calculation.

2. Description of the Related Art

An image histogram is a distribution of pixel values in a given image. The image histogram provides an entire representation of the appearance of an image, and can be applied with some operations to enhance the quality of an image. In a typical digital camera, an image signal processor (ISP) includes sub-modules, such as auto-exposure (AE) module and contrast module, which require image histogram information. Different modules or sub-modules may require different granularities of histogram bins. In other words, the requirement of image histogram information varies in different scale, accuracy, and unit of image data. For example, a full-scale image histogram with respect to gray-level values of green color of an image is required. In another example, a full-scale image histogram with respect to brightness of an image is required, and a bin-size of four gray-levels is sufficient.

In practice, a digital camera with a full-scale gray-levels of 8 bits, i.e. 256 gray levels, should provide circuitry for 256-bin histogram calculation in order to meet various requirements from a low-scale to a full-scale histogram calculation. However, such implementation requires high hardware cost. In addition, the computation resource provided by such circuitry may not be sufficiently utilized since the modules of the digital camera may not require full-scale accuracy from time to time. Therefore, it is desirable to provide an approach to image histogram calculation to make the best use of the computation resource provided by the corresponding hardware and achieve a reduced hardware cost.

### SUMMARY OF THE INVENTION

It is therefore an object of the invention to provide an apparatus and method for calculating histograms with configurable granularity. According to the invention, histogram values of a histogram for an M-bit image with different requirements can be calculated using a histogram calculation circuit in one or more iterations. The circuit includes N cumulative calculation devices, each of which, in response to an image data signal, is used for outputting a histogram value according to a corresponding pair of boundary. values, where N is smaller than 2^{m}. The boundary values of the cumulative calculation devices are configurable. For a histogram for a given image frame, histogram values can be obtained with one or more iterations using the histogram calculation circuit. In an image preview mode or video playback mode, neighboring frames that are highly correlated can be adopted in histogram calculation so as to obtain a histogram with the neighboring frames. Thus, computation resource provided by the corresponding circuit can be sufficiently utilized and a reduced hardware cost can be achieved.

The invention achieves the above-identified object by providing an apparatus for image histogram calculation to obtain a histogram of an M-bit image with a bin number of B, wherein pixel values of the M-bit image are between 0 and 2^{M}. The apparatus includes a histogram calculation circuit and a controlling unit. The histogram calculation circuit includes N cumulative calculation devices, each of which, in response to an image data signal, is used for outputting a histogram value according to a corresponding pair of boundary values, wherein N is smaller than 2^{M}. The controlling unit is used for controlling the histogram calculation circuit to obtain B histogram values of the histogram. The controlling unit determines a plurality of pairs of boundary values to set the histogram calculation circuit and determines a number of times, denoted by T, that the image data signal is input thereto, according to N, the bin number B, and maximum and minimum pixel values to be calculated for the histogram, in order to obtain the B histogram values of the histogram, wherein T≧1. When the controlling unit controls the histogram calculation circuit to determine T sets of histogram values as the B histogram values, the controlling unit sets the N cumulative calculation devices to have the pairs of boundary values determined by the controlling unit for a k-th time correspondingly, inputs the image data signal to the N cumulative calculation devices whose boundary values are set for the k-th time to calculate a k-th set of histogram values, and reads the k-th set of histogram values from the histogram calculation circuit, until the T sets of histogram values are read from the histogram calculation circuit, wherein 1≦k≦T.

The invention achieves the above-identified object by providing a method for image histogram calculation to obtain a histogram of an M-bit image with a bin number of B, wherein pixel values of the M-bit image are between 0 and 2M. The method includes steps a) and b). In step a), how to control a histogram calculation circuit including N cumulative calculation devices to obtain the histogram is determined, wherein each of the N cumulative calculation devices, in response to an image data signal, is used for outputting a histogram value according to a corresponding pair of boundary values, and N is smaller than 2M. Step a) includes determining a plurality of pairs of boundary values for setting the histogram calculation circuit and determining a number of times, denoted by T, that the image data signal is input thereto, according to N, the bin number B, and maximum and minimum pixel values to be calculated for the histogram, in order to obtain B histogram values of the histogram, wherein T≧1. In step b), the histogram calculation circuit is controlled to determine T sets of histogram values as the B histogram values. Step b) includes the steps from p) to s). In step p), the N cumulative calculation devices are set to have the pairs of boundary values determined for a k-th time correspondingly. In step q), the image data signal is input to the N cumulative calculation devices whose boundary values are set for the k-th time in order to calculate a k-th set of histogram values. In step r), the k-th set of histogram values are read from the histogram calculation circuit. In step s), the method proceeds from step p) until the T sets of histogram values are read from the histogram calculation circuit, wherein 1≦k≦T.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a digital camera system using a sub-system for calculating image histograms with configurable granularity according to an embodiment of the invention.

FIG. 2 is an example of the histogram calculation circuit shown in FIG. 1 according to an embodiment of the invention.

FIG. 3 is a flowchart illustrating a method for calculating image histograms with configurable granularity using a histogram calculation circuit according to an embodiment of the invention.

FIG. 4 shows an example of an image histogram completed according to the invention.

### DETAILED DESCRIPTION OF THE INVENTION

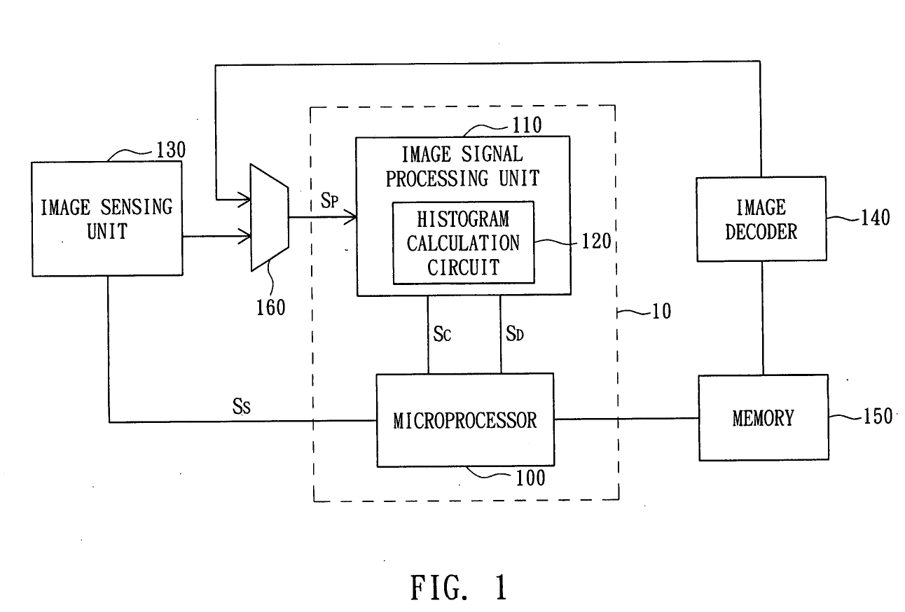

Referring to FIG. 1, a digital camera system is illustrated using a sub-system for calculating image histograms with configurable granularity according to an embodiment of the invention. In FIG. 1, the digital camera system includes a sub-system 10, an image sensing unit 130, an image decoder 140, a memory 150, and a selector 160. The sub-system 10 for calculating image histograms includes a controlling unit, such as a microprocessor 100 or a microcontroller, and an image signal processing unit 110 that includes a histogram calculation circuit 120. The histogram calculation circuit 120 includes a limited number N_{HW} of cumulative calculation devices for calculation of a histogram of an M-bit image, where N_{HW} is smaller than 2^{M}. The M-bit image is an image, each of pixels (i.e. fundamental picture elements) of which requires M bits for recording the pixel value. Therefore, the pixel values of the M-bit images are between from 0 to 2^{M}. The histogram of the M-bit image may have various bin size, and in a full-scale n-bin histogram of the M-bit image, the bin size can be equally set to 2^{M} /n, for example.

Under the condition that N^{HW} is smaller than 2^{m}, the microprocessor 100 controls the histogram calculation circuit 120 according to a request for an image histogram to calculate histogram values in order to obtain the required image histogram. The requirement of the image histogram may vary in scale, i.e. total number of bins, bin-size, and minimum and maximum pixel values to be calculated for a histogram. In response to the requirement, the microprocessor 100 determines how to make use of the histogram calculation circuit 120, for example, by setting the boundaries of the cumulative calculation devices of the histogram calculation circuit 120, to obtain the required histogram. In addition, when the digital camera system operates in a specific image mode, such as image preview, image display, or video playback, and a request for image histogram is issued, the microprocessor 100 determines how to feed appropriate image data into the histogram calculation circuit 120. Depending on the requirement, the required histogram, i.e. the distribution of pixel values, may be obtained in one or more iterations through the histogram calculation circuit 120 controlled by the microprocessor 100. The microprocessor 100 can effectively use the histogram calculation circuit 120 to obtain a histogram with respect to different requirement in order to make use of the computation resource provided by the histogram calculation circuit 120.

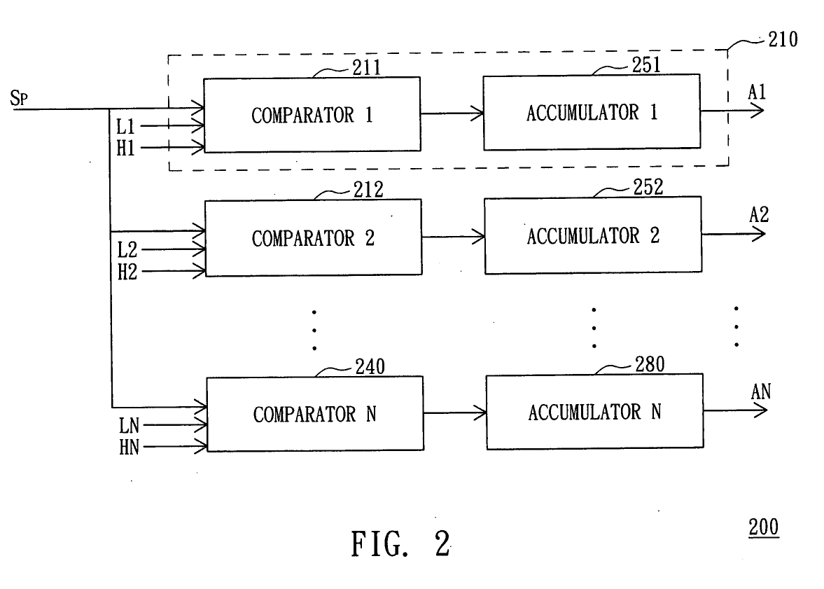

Referring to FIG. 2, one example of the histogram calculation circuit 120 shown in FIG. 1 is illustrated according to the invention. In FIG. 2, a histogram calculation circuit 200 includes a limited number N_{HW} of cumulative calculation devices, where N_{HW} is smaller than 2^{M}. Each cumulative calculation device includes a comparator and an accumulator coupled to the comparator. For example, the cumulative calculation device 210 includes a comparator 211 and an accumulator 251, coupled to the comparator 211. The comparator 211 has an input for receiving an image data signal Sₚ and two inputs for setting the comparator 211 to have a pair of boundary values of L1 and H1. When the image data signal Sₚ indicates a pixel value lying between L1 and H1, the 211 outputs a comparison signal indicating a value of 1, for example. In response to the comparison signal indicating a value of 1, the accumulator 251 increases an internal count number by one and outputs an accumulation signal indicating the internal count number. Also, the accumulation signal can be regarded as a histogram value A1.

For each iteration, the internal count numbers of the N accumulators 251, 252 to 280 are initially set to zero, and the upper limit and the lower limit of the N comparators 211, 212 to 240 are set accordingly, where the setting can be done by a control signal S_{c} from the microprocessor 100. The approach to applying signals to control the comparators and accumulators by the control signal S_{c} can be implemented in different ways. In one example, a logic circuit can be implemented to convert the control signal S_{c} from the microprocessor 100 into a plurality of signals indicating boundary settings for the comparators and control signals for controlling the accumulator. In addition, for each iteration, the image data signal Sₚ indicates a sequence of pixel values of an image frame. In this way, the histogram calculation circuit 200 results in a set of histogram values A1 to AN after one iteration.

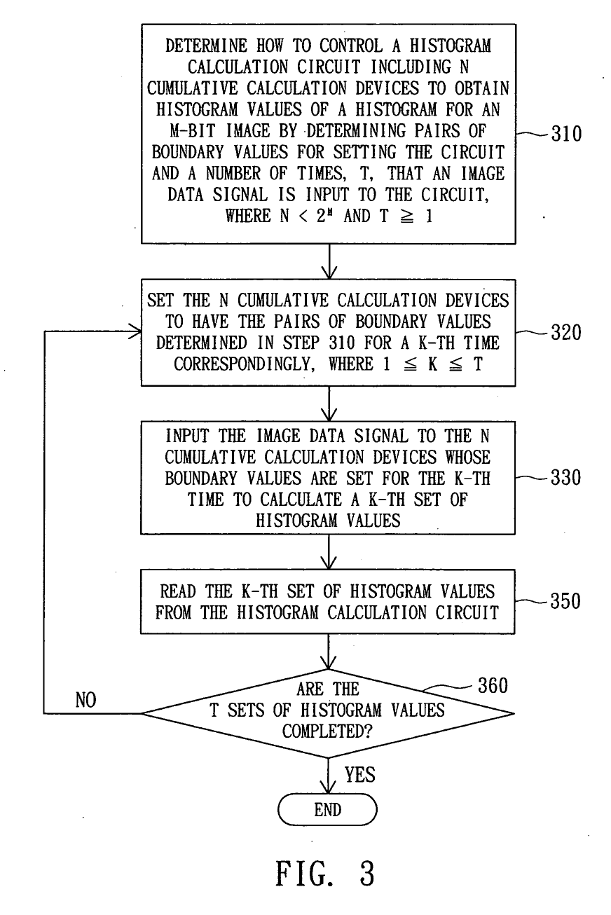

FIG. 3 illustrates a method for calculating image histograms with configurable granularity using a histogram calculation circuit according to an embodiment of the invention. For example, the microprocessor 100 in FIG. 1 can use this method to control the histogram calculation circuit 120 including N cumulative calculation devices to obtain a required histogram of an M-bit image with a bin number of B. Each of the N cumulative calculation devices, in response to an image data signal, is used for outputting a histogram value according to a corresponding pair of boundary values, and N is smaller than 2^{M}. Referring to FIG. 3, how to control the histogram calculation circuit to obtain the histogram is firstly determined, as indicated by step 310. In step 310, in order to obtain B histogram values of the histogram, a plurality of pairs of boundary values for setting the histogram calculation circuit and a number of times, denoted by T, that the image data signal is input to the histogram calculation circuit are determined according to N, the bin number B, and maximum and minimum pixel values to be calculated for the histogram, wherein T is an positive integer not smaller than 1.

After that, the histogram calculation circuit is controlled to determine T sets of histogram values to be the B histogram values of the histogram, as indicated by steps 320 to 360. In step 320, the histogram calculation circuit is configured according to the determination made in step 310 by setting the cumulative calculation devices of the histogram calculation circuit to have the pairs of boundary values determined for a k-th time correspondingly, where 1 ≦k≦T. In step 330, the image data signal is then input to the cumulative calculation devices whose boundary values are set for the k-th time in order to calculate a k-th set of histogram values. After that, in step 350, the k-th set of histogram values for this iteration are read from the histogram calculation circuit. In step 360, a determination is made as to whether the histogram calculation circuit has generated T sets of histogram values. If not, the method proceeds to step 320 to begin the next iteration, as indicated in step 360, until T sets of histogram values are generated by the histogram calculation circuit. If it is so in step 360, as indicated in step 370, the method ends.

In step 310, in order to obtain B histogram values of the histogram, the image data signal is determined to be input to the histogram calculation circuit for T time(s), that is, for T iteration(s) and the pairs of boundary values of the cumulative calculation devices of the histogram calculation circuit for each iteration are determined. For example, an n-bin histogram of an M-bit image is required, where n is larger than the number of cumulative calculation devices N_{HW}. If M=8, n=256, N_{HW}=64, and pixel values between 0 to 2^{M}-1 (=255) are to be calculated for the histogram, the bin size can be taken equally as 2^{M}/n=256/256=1. According to this requirement, the microprocessor 100 controls the histogram calculation circuit 120 to iterate over a number of computation cycles (i.e. 4 iterations) until the values of the required histogram are obtained. The number of iterations can be symbolically expressed by: Nᵢₜₑᵣₐₜᵢₒₙ =ceiling ((H_{H}−H_{L}+1) /(S_{BIN}•N_{Hw})), where H_{H} and H_{L} indicate maximum and minimum pixel values to be calculated for the required histogram, respectively, S_{BIN} denotes the bin size of the required histogram, and the ceiling of a number is the smallest integer greater than or equal to the number. If the above example of a full-scale histogram is taken, where H_{H}=2^{M}−1=255, H_{L=}0, S_{BIN}=1, and N_{HW}=64, then the number of iterations N_{iteration=ceiling(}256/64)=4.

Correspondingly, pairs of boundary values of the histogram calculation circuit can be computed. In the first iteration, the 64 cumulative calculation devices 1 to N_{HW} are set to have boundaries according to the following sequence of pairs of numbers, respectively: (0,0), (1,1), . . . , (Ln, Hn), . . . ,(63,63), wherein a pair of number (Ln, Hn) indicate a lower limit and an upper limit for the n-th cumulative calculation device and Ln=Hn indicating that the bin size is 1. In the second iteration, the 64 cumulative calculation devices 1 to N_{HW} are set to have boundaries according to the following sequence of pairs of numbers, respectively: (64,64), (65,65), . . . , (127,127). The boundary settings for the third and fourth iterations can be made similarly.

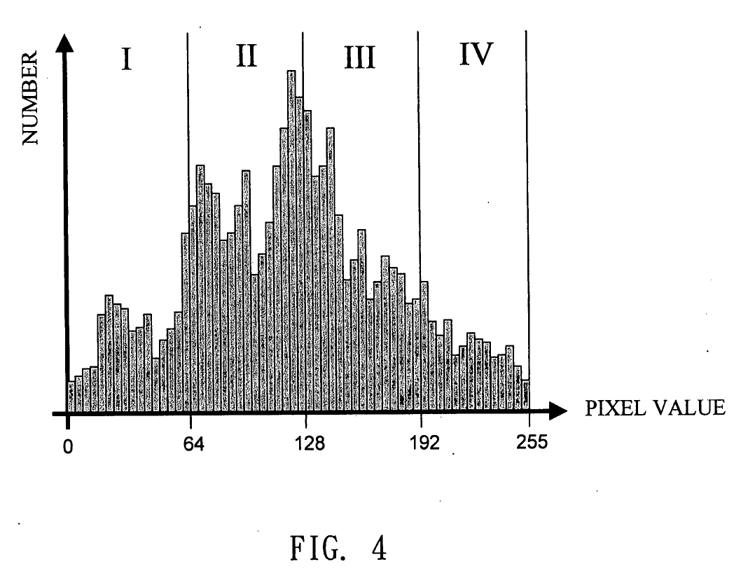

In each iteration from steps 320 to 360, the microprocessor 100 sets the cumulative calculation devices of the histogram calculation circuit 120 with different boundaries through a control signal S_{c}, feeds the image data Sₚ of the given image into the histogram calculation circuit 120, and then reads the computation results of the iteration, denoted by S_{D}. In the example, the first iteration results in 64 histogram values, denoted by S_{D1}, corresponding to pixel values from 0 to 63, and the second one results in another 64 histogram values S_{D2} corresponding to pixel values from 64 to 127. Similarly, after the four iterations, the required histogram is achieved; that is, the four sets of histogram values of S_{D1}, S_{D2}, S_{D3}, SD_{D4} are obtained. FIG. 4 illustrates an example of an image histogram obtained after four iterations, as indicated by I, II, III, IV, according to the invention, wherein FIG. 4 is for illustration only so that based on various requirements, the bin number and bin size of the histogram may be different from the above example.

In another example, in step 310, if the bin size of the required histogram is 4, then the iteration number Nᵢₜₑᵣₐₜᵢₒₙ=ceiling(256/(4×64))=1. In this case, only one iteration is performed, in step 320, the 64 cumulative calculation devices 1 to N_{HW} are set to have boundaries according to the following sequence of pairs of numbers, respectively: (0,3), (4,7), . . . ,(252,255). Therefore, for example, the histogram value A1, as indicated in FIG. 2, will be the number of pixels whose pixel values are between 0 and 3. In this way, 64 histogram values are obtained after the iteration.

In the above examples, the histogram is completed by feeding the same image frame into the histogram calculation circuit for calculating histogram values in step 330. Namely, for each of iteration, the same image frame is input for histogram calculation. When the number of iterations is 4, the same image frame has to be repeatedly input four times for histogram calculation. This case happens, for example, when the digital camera system, as shown in FIG. 1, operates in an image display mode where an image file, for example, stored in JPEG format, is displayed and a histogram is required. Referring to FIG. 1, the image file is stored in the memory 150 and then decoded by the image decoder 140. The microprocessor 100 controls the selector 160 to feed the image data, indicated by Sₚ, of the decoded image file from the image decoder 140 into the histogram calculation circuit 120 of the image signal processing unit 110. In this way, appropriate image data is fed into the histogram calculation circuit 120, as indicated in step 330.

However, when the digital camera system operates in an image preview mode or a video playback mode, and a request for an image histogram is issued, the microprocessor 100 needs to determine image data of which image frames should be fed into the histogram calculation circuit 120.

In an image preview mode or a video playback mode, when a histogram is required, the digital camera system can apply the method of the present invention to achieve a histogram by using neighboring frames from an image source in step 330 for successive iterations, if necessary. The neighboring frames are a sequence of frames from the image source. It is assumed that the neighboring frames are highly correlated, and can be approximately regarded as the “same” frames. By this assumption, when the method shown in FIG. 3 is applied in the image preview mode or the video playback mode, the neighboring frames can be approximately regarded as the “same” frames and successively fed into the histogram calculation circuit in successive iterations.

In the image preview mode, the microprocessor 100 controls the selector 160 to feed the image data, indicated by Sₚ, captured by the image sensing unit 130 into the histogram calculation circuit 120 of the image signal processing unit 110. The image sensing unit 130, for example, captures and outputs 15 frames per second. One of the neighboring frames captured by the image sensing unit 130 is input to the histogram calculation circuit 120 to be the image data indicated by Sₚ in each of iterations. If a histogram for an 8-bit image having bin number of 256 and bin size of 1 and the number of the histogram calculation devices is 64, then the number of iterations Nᵢₜₑᵣₐₜᵢₒₙ=ceiling(256/64)=4. Correspondingly, boundary values of the histogram calculation circuit can be determined as mentioned above. In each of iterations, from steps 320 to 360, the microprocessor 100 sets the boundary values of the histogram calculation circuit 120 with different boundaries by a control signal S_{c}, feeds the image data Sₚ of one of the neighboring frames to the histogram calculation circuit 120, and then reads the computation result of the iteration, denoted by S_{D}. It is noted that in step 330, for each of iterations, the image data of one of the neighboring frames captured by the image sensing unit 130 is input. The first iteration results in 64 histogram values, denoted by S_{D1}, corresponding to pixel values from 0 to 63 with respect to a first neighboring frame. The second one results in another 64 histogram values S_{D2} corresponding to pixel values from 64 to 127 with respect to a second neighboring frame. Similarly, after the four iterations, the required histogram is achieved; that is, the four sets of histogram values of S_{D1}, S_{D2}, S_{D3}, S_{D4} are obtained with respect to four neighboring frames respectively.

It is assumed that the four neighboring frames are highly correlated and may be approximately regarded as the “same” frames, and the required histogram is obtained according to a number of neighboring frames. For sake of illustration, FIG. 4 can be regarded as an example of an image histogram obtained in the image preview mode after four iterations, as indicated by I, II, III, IV, and each of the four iterations respectively has one of the neighboring frames for histogram values calculation.

In the video playback mode, a video image file is stored in the memory 150 and then decoded by the image decoder 140. After decoding, a sequence of image frames is outputted from the image decoder 140. The microprocessor 100 controls the selector 160 to feed the image data, indicated by Sₚ, of the decoded image frames from the image decoder 140 into the histogram calculation circuit 120 of the image signal processing unit 110. One of the neighboring frames from the image decoder 140 is input to the histogram calculation circuit 120 to be the image data indicated by Sₚ in each of iterations. Therefore, a required histogram can be obtained with a number of neighboring frames of the video file.

In the above examples for applying the method shown in FIG. 3 to the image preview mode and video playback mode, it is assumed that the neighboring frames are highly correlated and can be approximately regarded as the “same” frames for histogram calculation. In some situations, neighboring frames may be distinct from one another or lowly correlated. For example, when a user takes the digital camera to focus on different objects from one to another rapidly, the neighboring frames will be lowly correlated and be distinct from one another. A histogram that is obtained over the lowly-correlated neighboring frames is not reliable and may be mistaken. Thus, one or more criteria for determining whether the neighboring frames are highly correlated are required. When it is determined that one or more criteria happen, indicating that lowly-correlated neighboring frame may be used in histogram calculation, the method can be reset so as to restart the histogram calculation, in order to make the histogram computation more accurate and reliable. In this case, the cumulative calculation devices of the histogram calculation circuit are reset by the microprocessor, for example, to determine the histogram values of the histogram again.

The criteria for determining whether the neighboring frames are highly correlated can be defined according to one or more parameters indicating image characteristic, which may be a statistical parameter of a frame. In one embodiment, if exposure or white balance gain setting is dramatically changed, the correlation of the previous and current frames will be low. If the exposure or white balance gain setting is being adjusted during histogram calculation, the iteration is reset, and the method proceeds to step 320 so as to perform the calculation from the beginning of the first iteration. For example, if white balance gain setting is changed with a difference over a threshold value, e.g. 0.2, the correlation of the previous and current frames will be low. Therefore, if the white balance gain setting has an increase of 0.1, the iteration will not be reset, and if the white balance gain setting has an increase of 0.3, which is over the threshold of 0.2, the iteration is reset. Further, in this embodiment, the microprocessor 100 generates a control signal Sₛ indicating the white balance gain setting and sends the control signal Sₛ to the image sensing unit 130. By detecting the control signal Sₛ, any change of the setting can be determined so as to decide whether to reset the iteration.

The method shown in FIG. 3 can be implemented as a software program stored in the memory 150 and executed by the microprocessor 100, for example. In another example, the microprocessor 100 can be a microcontroller including an internal memory storing software instructions implementing this method. In another example, the method can be implemented by circuitry and the histogram calculation circuit and the circuitry can be integrated into one chipset.

The above embodiments illustrate an apparatus and method for calculating histogram with configurable granularity. According to the invention, a histogram calculation circuit including a limited number of cumulative calculation devices is provided for calculation of image histograms with different requirements in one or more iterations. According to the invention, the boundary values of each of the cumulative calculation devices is configurable so that in each iteration the bin size and bin number, if necessary, can be adjusted and are not limited to a fixed bin size and a fixed bin number. In addition, if required is a histogram with a smaller scale than the full-scale or a histogram with respect to a range of pixel values, for example, pixel values from 64 to 128, the method can compute appropriate boundaries in step 310 and configure the histogram calculation circuit in step 320 so as to obtain the histogram fulfilling this requirement. Further, image processing or another image analysis statistics, such as cumulative distribution function, can be computed according to the obtained histogram values. Thus, computation resource provided by the corresponding circuit can be sufficiently utilized and a reduced hardware cost can be achieved.

Furthermore, in the above embodiments and examples, the pixel values of an M-bit image can be regarded as gray-level values of corresponding pixels for a monochrome image or gray-level values of corresponding sub-pixels with respect to a specific color (e.g. green) for a color image. Those skilled in the art will recognize that a pixel can also be represented by another representation such as component signal or the gray-level values of pixels can also be converted into another representation. Accordingly, an image histogram with respect to brightness Y, for example, can also be obtained according to the invention.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for image histogram calculation to obtain a histogram of
an M-bit image with a bin number of B, wherein pixel values of the
M-bit image are between 0 and 2^{M}, the apparatus comprising:
a histogram calculation circuit including N cumulative calculation devices, each of which, in response to an image data signal, is used for outputting a histogram value according to a corresponding pair of boundary values, wherein N is smaller than 2^{M}; and
a controlling unit for controlling the histogram calculation circuit to obtain B histogram values of the histogram,
wherein the controlling unit determines a plurality of pairs of boundary values to set the histogram calculation circuit and determines a number of times, denoted by T, that the image data signal is input thereto, according to N, the bin number B, and maximum and minimum pixel values to be calculated for the histogram, in order to obtain the B histogram values of the histogram, wherein T≧1;
wherein when the controlling unit controls the histogram calculation circuit to determine T sets of histogram values as the B histogram values, the controlling unit sets the N cumulative calculation devices to have the pairs of boundary values determined by the controlling unit for a k-th time correspondingly, inputs the image data signal to the N cumulative calculation devices whose boundary values are set for the k-th time in order to calculate a k-th set of histogram values, and reads the k-th set of histogram values from the histogram calculation circuit, until the T sets of histogram values are read from the histogram calculation circuit, wherein 1≦k≦T.

2. The apparatus according to claim 1, wherein in order to calculate the T set of histogram values with a given image frame, the controlling unit inputs the image data signal indicating the given image frame to the N cumulative calculation devices.

3. The apparatus according to claim 1, wherein in order to calculate the T set of histogram values with a sequence of frames to be input, the controlling unit inputs the image data signal indicating one of neighboring frames of the sequence of frames to the N cumulative calculation devices for the k-th time.

4. The apparatus according to claim 3, wherein:
the controlling unit is further used for detecting a parameter indicating image characteristics; and
the controlling unit resets the histogram calculation circuit to determine the T sets of histogram values again after the controlling unit detects that the parameter is changed.

5. The apparatus according to claim 4, wherein the parameter is an exposure setting, and the exposure setting that is changed indicates that two of the neighboring frames are lowly correlated.

6. The apparatus according to claim 4 wherein the parameter is a white balance gain setting, and the white balance gain setting that is changed indicates that two of the neighboring frames are lowly correlated.

7. The apparatus according to claim 3, wherein:
the controlling unit is further used for detecting a parameter indicating image characteristics;
the controlling unit resets the histogram calculation circuit to determine the T sets of histogram values again after the controlling unit detects that the parameter is changed with a difference over a threshold value.

8. The apparatus according to claim 7 wherein the parameter is an exposure setting, and the exposure setting that is changed with the difference over the threshold value indicates that two of the neighboring frames are lowly correlated.

9. The apparatus according to claim 7, wherein the parameter is a white balance gain setting, and the white balance gain setting that is changed with the difference over the threshold value indicates that two of the neighboring frames are lowly correlated.

10. The apparatus according to claim 1, wherein:
each of the N cumulative calculation devices comprising:
a comparator for outputting a comparison signal indicating whether the image data signal indicates a pixel value lying between the boundary values corresponding to the comparator; and
an accumulator, in response to the comparison signal, for increasing a count number if the comparison signal indicates that the pixel value indicated by the image data signal lies between the boundary values corresponding to the comparator, and for outputting an accumulation signal indicating the count number as one of the histogram values.

11. The apparatus according to claim 10, wherein the controlling unit resets the count number of the accumulator before inputting the image data signal to the N cumulative calculation devices.

12. A method for image histogram calculation to obtain a histogram of an M-bit image with a bin number of B, wherein pixel values of the M-bit image are between 0 and 2^{M}, comprising:
a) determining how to control a histogram calculation circuit including N cumulative calculation devices to obtain the histogram, wherein each of the N cumulative calculation devices, in response to an image data signal, is used for outputting a histogram value according to a corresponding pair of boundary values, and N is smaller than 2^{M}, step a) comprising:
determining a plurality of pairs of boundary values for setting the histogram calculation circuit and determining a number of times, denoted by T, that the image data signal is input thereto, according to N, the bin number B, and maximum and minimum pixel values to be calculated for the histogram, in order to obtain B histogram values of the histogram, wherein T≧1;
b) controlling the histogram calculation circuit to determine T sets of histogram values as the B histogram values, step b) comprising:
p) setting the N cumulative calculation devices to have the pairs of boundary values determined for a k-th time correspondingly;
q) inputting the image data signal to the N cumulative calculation devices whose boundary values are set for the k-th time in order to calculate a k-th set of histogram values;
r) reading the k-th set of histogram values from the histogram calculation circuit; and
s) proceeding from step p) until the T sets of histogram values are read from the histogram calculation circuit, wherein 1≦k≦T.

13. The method according to claim 12, wherein in order to calculate the T set of histogram values with a given image frame, in step q), the image data signal indicates the given image frame.

14. The method according to claim 12, wherein in order to calculate the T set of histogram values with a sequence of frames, in step q), the image data signal input to the N cumulative calculation devices for the k-th time indicates one of neighboring frames of the sequence of frames.

15. The method according to claim 14, further comprising:
determining whether a parameter indicating image characteristics with respect to the image data signal has changed; and
if so, resetting the method by proceeding to step b).

16. The method according to claim 15, wherein the parameter is an exposure setting, and the exposure setting that has changed indicates that two of the neighboring frames are lowly correlated.

17. The method according to claim 15, wherein the parameter is a white balance gain setting, and the white balance gain setting that has changed indicates that two of the neighboring frames are lowly correlated.

18. The method according to claim 14, further comprising:
determining whether a parameter indicating image characteristics with respect to the image data signal has changed with a difference over a threshold value; and
if so, resetting the method by proceeding to step b).

19. The method according to claim 18, wherein the parameter is an exposure setting, and the exposure setting that has changed with the difference over the threshold value indicates that two of the neighboring frames are lowly correlated.

20. The method according to claim 18, wherein the parameter is a white balance gain setting, and the white balance gain setting that has changed with the difference over the threshold value indicates that two of the neighboring frames are lowly correlated.
